(19) United States
(12) Patent Application Publication
(10) Pub. No.: US 2013/0104806 A1
(43) Pub. Date: May 2, 2013

(54) HYBRID COVER FOR THE CONSTRUCTION OF A PILLOW BED FOR PETS

(71) Applicant: Edward P. Dennis, Conifer, CO (US)

(72) Inventor: Edward P. Dennis, Conifer, CO (US)

(73) Assignee: TOPET USA, INC., Morrison, CO (US)

(21) Appl. No.: 13/311,407

(22) Filed: Dec. 5, 2011

Related U.S. Application Data
(60) Provisional application No. 61/553,085, filed on Oct. 28, 2011.

(51) Int. Cl. A01K 29/00; B65D 85/00

(52) U.S. Cl. 119/28.5; 206/525

(57) ABSTRACT

A hybrid cover for use in the construction of a pet bed that may make use of a used pillow for a cushioning member in conjunction with the hybrid cover in constructing the pet bed. The hybrid cover includes a bed portion and a flap portion that may be disposed in an overlapping and non-overlapping position with respect to the bed portion. A pillow may be provided in an interior space of the bed portion. The pillow may have a scent that is smellable at an exterior of the hybrid cover when a pet bed is constructed using the hybrid cover and the pillow.

### CROSS REFERENCE TO RELATED APPLICATIONS

This application claims priority to U.S. Provisional Application No. 61/553,085 filed Oct. 28, 2011 entitled “PILLOW BED FOR PETS”, the entirety of which is incorporated herein by reference.

### BACKGROUND

Many pet owners may provide a pet with a bed on which the pet may rest. For example, pet owners may provide a pet bed in a bedroom or living area such that a pet may lie on the pet bed while still being near the pet owner. Oftentimes, pet beds of this nature include cushioning that provides a cushioned bed surface on which the pet may lie. In this regard, pet beds may be relatively large and/or bulky as the cushioning may be large enough to provide a sufficient area on which the pet may lie and may be relatively thick in order to provide a degree of plushness.

The relatively large size of a pet bed is a particular disadvantage in the context of the retail sale of pet beds. In a first regard, the relatively large size of pet beds may limit the available retail space that may be dedicated to the display of such pet beds. That is, a relatively large pet bed including a cushioning member provided therewith, when on display for sale, may occupy shelf space that could otherwise be available to display goods (e.g., other smaller and/or higher value goods).

Additionally, the relatively large size of pet beds may introduce additional costs related to the transport of the pet beds (e.g., to a retail location or directly to consumers). For example, the size of the pet beds may introduce high shipping costs due to the relatively large size of such beds, i.e., when shippers charge freight based in part on the girth of the package. In some instances, the cost of shipping a single pet bed may reach costs approaching, or even be higher than, the suggested retail price of such beds such that the shipping costs may become prohibitive. In any regard, the cost of such pet beds may be increased. For instance, even in the case of vendors that ship directly to customers, the shipping costs of such beds may add significantly to the cost of such pet beds.

Solutions have been proposed to address the high shipping costs of these beds, yet none have been viable options for addressing the problems associated with shipping large pet beds. For example, it has been proposed to vacuum package pet beds in an effort to reduce the dimensions of the beds for transport. However, while vacuum packaging may reduce the overall dimensions of a bed for shipping, it may also unacceptably permanently deform the bed. Furthermore, while reducing transport cost associated with the overall size of the packaged pet bed, the cost of a vacuum bag and the cost of labor associated with packaging and unpack aging the beds is still high. Thus, the cost of a vacuum packaged bed may still be increased. In turn, it has been proposed to package multiple beds in a single vacuum bag. However, this introduced additional complexity as, for example, the multiple beds contained in a single vacuum bag may be mistakenly sold as a single unit rather than as multiple units as intended.

### SUMMARY

In light of the foregoing, it is recognized that a convenient, economical hybrid cover for the construction of a pet bed may be provided for constructing a pet bed that overcomes the foregoing disadvantages discussed in relation to previous pet beds. In this regard, the hybrid cover disclosed herein may be substantially smaller than previous pet beds, such that the foregoing problems related to the size of pet beds are overcome by the hybrid cover. For example, the hybrid cover may be provided and/or sold without the inclusion of a cushioning member. Rather, the cushioning member may be provided by a user of the hybrid cover to construct a pet bed using the hybrid cover.

Additionally, the hybrid cover disclosed herein may enable a consumer to construct a pet bed exhibiting specific advantages over previous pet beds. Specifically, pet beds described herein may be constructed using a conventional standard sized (e.g., human) pillow as a cushioning member that may, at least in some instances, be provided by a consumer after the purchase of the hybrid cover for the pet bed. For example, it is recognized that individuals may replace the pillows used on their own beds (e.g., pillows used to cushion the head of the user) from time to time. Such head pillows are often provided in standard sizes. For example, an individual may purchase a new head pillow periodically to replace a used head pillow. In this regard, used pillows are often disposed of by simply throwing away the used pillow. In light of the availability of standard sized used pillows, a hybrid cover described herein may be sold to consumers without a cushioning member. Accordingly, the disadvantages described above regarding the relatively large size of pet beds that include a cushioning member may be overcome.

The use of a used human pillow may also provide additional advantages in that the scent of the owner or caretaker of a pet may be present on the used pillow. The scent of the used pillow may in turn be smellable at an exterior of the pet bed constructed using a hybrid cover and a used pillow. As such, the pet may be able to smell the scent of the owner or caretaker when near the pet bed, which may be comforting to the pet. Additionally, the use of standard human pillows that are readily available may allow for convenient replacement of the cushioning member of a pet bed constructed using a hybrid cover. For instance, especially in the case of young and old pets, a pet may experience urinary incontinence when laying on a pet bed or the pet bed may otherwise become soiled. The soiling of previous pet beds may result in costly and labor intensive cleaning of the cushioning member such that the cost and burden of cleaning the bed becomes prohibitive if cleaning is even possible. In many instances, upon the soiling of previous pet beds, the cushioning member is unable to be cleaned (e.g., due to the size of the cushioning member, the material of the cushioning material, etc.) and the cushioning member must be discarded. The cushioning members are often difficult, if not impossible to replace. As such, the pet bed may need to be replaced. However, a pet bed constructed using a hybrid cover and standard sized human pillow according to the present disclosure may allow for convenient washing of the cover and/or cushioning member or even replacement of the cushioning member with another standard sized human pillow. Because of the prevalence and relatively low cost of standard sized human pillows, replacement of a soiled pillow may be much more convenient and cost effective than the replacement or cleaning of cushioning members of prior pet beds.

In this regard, a first aspect disclosed herein comprises a hybrid cover for the construction of a pet bed. The hybrid cover includes a bed portion comprising at least one fabric panel defining an interior space that is selectively accessible from an exterior of the bed portion. The hybrid cover also includes a flap portion secured to the bed portion that extends therefrom. The interior space is sized to receive at least one cushioning member within the interior space, and at least a part of the flap portion is displaceable with respect to the bed portion between an overlapping and non-overlapping position.

Various feature refinements and additional features exist in relation to the first aspect of the present invention. These feature refinements and additional features may exist individually or in any combination. For instance, various features discussed below in relation to any of the exemplary embodiments of the present invention may be incorporated into the first aspect of the present invention alone or in any combination.

For example, in an embodiment, the bed portion may comprise an opening through which a cushioning member may be passed when the cushioning member is received in the interior space. In one embodiment, the opening may be at least partially defined by overlapping fabric portions secured along opposing edges thereof. The opening may be securable by a closure device.

Additionally, the at least one fabric panel comprising the bed portion may be permeable to smell. Accordingly, a scent of a cushioning member may be smellable at an exterior of the bed portion when the cushioning member is disposed in the interior space. The flap portion may include an attachment portion secured to the bed portion and a free portion displaceable with respect to the bed portion. The attachment portion may comprise a first edge portion of the flap portion. The free portion may comprise at least a second edge portion of the flap portion displaceable with respect to the bed portion. In one embodiment, the bed portion may comprise a plurality of fabric panels. For example, a first fabric panel of the plurality of fabric panels may comprise a first material and a second fabric panel of the plurality of fabric panels may comprise a second material. The first material may be different than the second material. The first panel may comprise a top surface of the bed portion and be made from, for example, a fleece material. As such, the fleece material may be provided on the top surface of the bed portion such that the pet may lie on a soft material. It may be that the remainder of the bed (e.g., at least a second panel of the bed portion) may be constructed from a material different than the first material. In this regard, the second material may be selected for properties different than the first material. For example, the second material may be a fabric that is resistant to wear, easily cleanable, and/or more economical than the first material. In one particular embodiment, the second material comprises a woven fabric, such as taffeta.

In one embodiment, the flap portion may comprise at least one fabric layer. The at least one fabric layer of the flap portion may be integral with a fabric panel of the bed portion (e.g., the first fabric panel). The flap portion may comprise a plurality of fabric layers. For example, a first fabric layer may be constructed of a third material and a second fabric layer may be constructed of a fourth material. It may be that the first material of the bed portion may be the same as the third material of the flap portion and the second material of the bed portion may be the same as the fourth material of the flap portion. In this regard, the flap portion may include a fleece material that is disposed such that the pet may lie on the relatively soft fleece material (e.g., when the flap portion is in a non-overlapping relation with respect to the bed portion). The remainder of the flap portion (e.g., at least the second fabric layer thereof) may be a durable, washable, and/or economical material such as taffeta.

In an embodiment, the interior space may be sized to receive a standard size human head pillow. For example, a standard sized human pillow may be approximately 20 inches (51 cm) by 26 inches (66 cm). Accordingly, the bed portion may be substantially rectangular in shape. The bed portion may have a length not less than about 18 inches (46 cm) and not more than about 24 inches (61 cm). For example, the bed portion may have a length that is about 20 inches (51 cm). The bed portion may have a width not less than about 24 inches (61 cm) and not more than about 28 inches (71 cm). For example, the bed portion may have a width that is about 26 inches (66 cm). In one embodiment, the first edge of the flap portion may extend along substantially the entire width of the bed portion.

In another embodiment, the interior space may be sized to receive a plurality of cushioning members, e.g., two cushioning members. For example, the interior space may comprise a plurality of compartments for receiving a respective one of the plurality of cushioning members or a plurality of cushioning members may be received into a single compartment. Accordingly, the bed portion may be correspondingly shaped to accept more than one standard sized pillow (e.g., such that the bed portion may have dimensions corresponding to some multiple of the dimensions of a standard pillow such as 40 inches (1.0 m) by 26 inches (66 cm), 40 inches (1.0 m) by 52 inches (1.3 m), etc.).

A second aspect includes a method of constructing a pet bed. The method includes providing a hybrid cover including a bed portion and a flap portion. The bed portion comprises at least one fabric panel defining an interior space that is selectively accessible from an exterior of the bed portion via an opening provided in the bed portion. The method further includes passing a cushioning member through the opening and into the interior space and closing the opening to retainably engage the cushioning member within the interior space to construct the pet bed. Furthermore, the method may include positioning the pet bed for access to the pet bed by an animal.

Various feature refinements and additional features exist in relation to the second aspect of the present invention. These feature refinements and additional features may exist individually or in any combination. For instance, various features discussed below in relation to any of the exemplary embodiments of the present invention may be incorporated into the first aspect of the present invention alone or in any combination.

For example, the interior space may be sized to receive a standard sized human pillow, and the cushioning member may comprise a standard sized human pillow. Additionally, the method may include moving the flap portion with respect to the bed portion between an overlapping position and a non-overlapping position. The fabric panel may be permeable to smell such that a scent of the cushioning member may be smellable at an exterior of the bed portion when the cushioning member is disposed in the interior space. Furthermore, the bed portion may be sized to receive multiple cushioning members (e.g., in a single interior space or into discrete portions of the bed portion).

A third aspect includes a packaged item for sale in a retail location. The packaged item includes a hybrid cover for constructing a pet bed. The hybrid cover includes a bed portion comprising at least one fabric panel defining an interior space that is selectively accessible from an exterior of the bed portion and a flap portion secured to the bed portion and extending therefrom. The interior space is sized to receive a cushioning member within the interior space, and at least a part of the flap portion is displaceable with respect to the bed portion between an overlapping and non-overlapping position. The packaged item also includes packaging material operable to contain the hybrid cover. The packaged item does not include a cushioning member. Therefore, the packaged item may have a weight of not greater than about 1 lb. (0.45 kg).

### BRIEF DESCRIPTION OF THE FIGURES

FIG. 1 depicts an embodiment of a hybrid cover for the construction of a pet bed in a non-overlapping position.

FIG. 2 depicts an embodiment of a hybrid cover for the construction of a pet bed in an overlapping position.

FIG. 3 depicts a top elevation view of a pet bed constructed using an embodiment of a hybrid cover.

FIG. 4 depicts a cross sectional view of the embodiment of the pet bed shown in FIG. 3 taken along section line 4-4.

FIGS. 5A-5C depict various embodiments of closure devices to secure an opening of an embodiment of a pet bed.

FIGS. 6A-6C depict various embodiments of a flap portion.

FIG. 7 depicts a top elevation view of a pet bed constructed using another embodiment of a hybrid cover.

FIG. 8 depicts a cross sectional view of the embodiment of the pet bed shown in FIG. 7 taken along section line 8-8.

FIGS. 9A-9C depict an embodiment of a packaged item including a hybrid cover for the construction of a pet bed.

### DETAILED DESCRIPTION

The following description is not intended to limit the invention to the form disclosed herein. Consequently, variations and modifications commensurate with the following teachings, skill and knowledge of the relevant art, are within the scope of the present invention. The embodiments described herein are further intended to explain modes known of practicing the invention and to enable others skilled in the art to utilize the invention in such, or other embodiments and with various modifications required by the particular applications(s) or use(s) of the present invention.

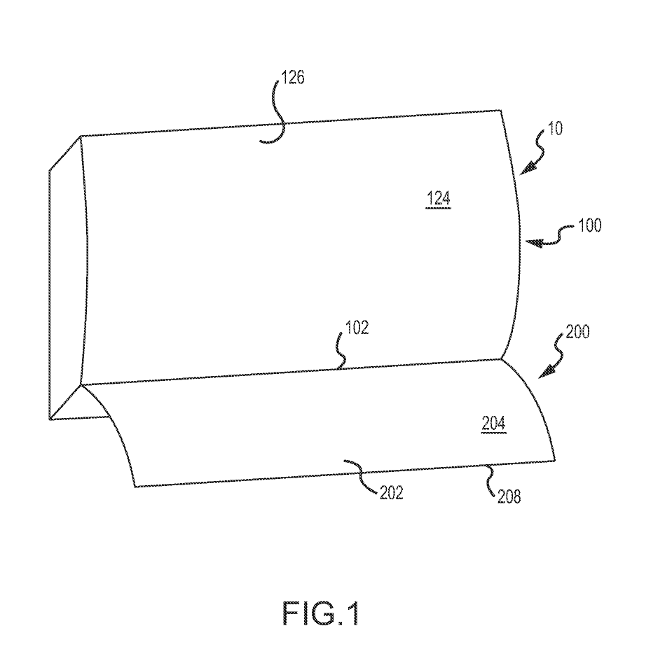

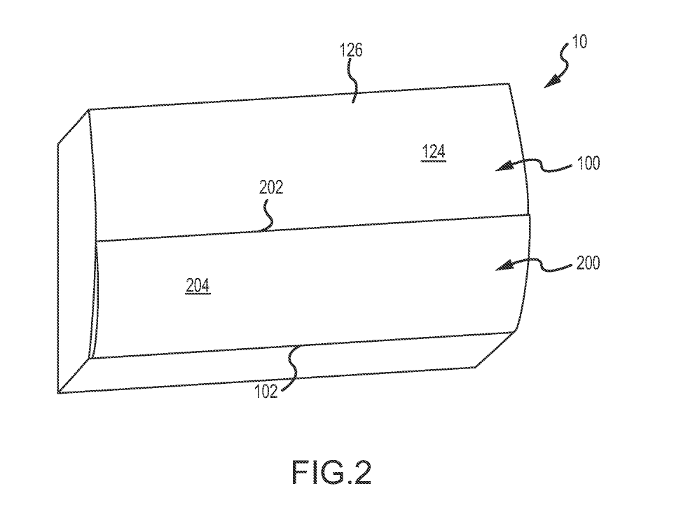

One embodiment of a hybrid cover 10 for the construction of a pet bed is depicted in FIG. 1. The hybrid cover 10 generally includes a bed portion 100 and a flap portion 200. The flap portion 200 may be attached to and extend from the bed portion 100. With further reference to FIG. 2, the flap portion 200 is shown in an overlapping position with respect to the bed portion 100. In FIG. 1, the flap portion 200 is shown in a non-overlapping position with respect to the bed portion 100. The flap portion 200 may comprise a separate portion secured to the bed portion 100 along the first edge 102 of the bed portion 100. The flap portion 200 may also include a free portion 202 that is moveable with respect to the bed portion 100 between the overlapping and non-overlapping positions. The free portion 202 may have at least one free edge 208. Alternatively, the flap portion 200 may be provided integrally with the bed portion 100 and may be displaceable with respect thereto between the overlapping and non-overlapping positions shown in FIGS. 1 and 2.

The flap portion 200 may be substantially the same size as a top surface 126 of the bed portion 100. As such, when the flap portion 200 is in the overlapping position, substantially all of the top surface 126 of the bed portion 100 may be covered by the flap portion 200. Alternatively, the flap portion 200 may be smaller than the top surface 126 of the bed portion 100 such that the flap portion 200 does not cover the entire top surface 126 of the bed portion 126 when in the overlapping position (as depicted in FIG. 2). Further still, the flap portion 200 may be larger than the top surface 126 of the bed portion 100 such that the flap portion 200 overhangs the top surface 126 of the bed portion 100 when in the overlapping position. It may also be that the flap portion 200 overhangs a portion of the top surface 126, while not extending to the entirety of another portion of the top surface 126 of the bed portion 100.

The bed portion 100 and/or flap portion 200 may comprise fabric. In this regard, one or more fabric panels 124 may comprise the bed portion 100 and one or more fabric layers 204 may comprise the flap portion 200. In any regard, the one or more fabric panels 124 and/or the one or more fabric layers 204 may be patterned or otherwise decorative so as to present an attractive appearance of the hybrid cover 10. The fabric comprising the one or more fabric panels 124 and/or the one or more fabric layers 204 may be any cotton or polyester based material. Furthermore, natural or synthetic materials such as sheep skin, shearling, fleece, wool, taffeta, or other appropriate materials may be used in the construction of the hybrid cover 10 without limitation. Fleece, a soft napped synthetic fabric made from polyethylene terephthalate (PET) or other synthetic fibers, may be preferred in some aspects. Such fabrics may provide desired properties of the pet bed such as durability, softness, insulation, or the like. In one embodiment, the one or more fabric panels 124 and the one or more fabric layers 204 may be the same material. In one embodiment, either or both of the bed portion 100 and the flap portion 200 may be constructed from a plurality of fabric panels 124 or fabric layers 204, respectively. In this regard, different ones of the fabric panels 124 and/or different ones of the fabric layers 204 may comprise different materials. For example, a first material may be provided on a first part of the bed portion 100 (e.g., the top surface 126) that is soft and a second material may be provided on a second part of the bed portion 100 (e.g., the remainder of the bed portion other than the top surface 126) that is wear resistant, easily washable, and/or more economical than the first material. Additionally, a combination of different materials may be provided on the top surface 126 of the bed. In one embodiment, the second material may be a taffeta material, or other appropriate material. Similarly, the flap portion 200 may be constructed from different materials in a similar respect such that a portion of the flap panel 200 on which the pet may lie (e.g., when the flap portion 200 is in a non-overlapping position with respect to the bed portion) may be a fleece material and the remainder of the flap portion may be a second material such as, for example, taffeta.

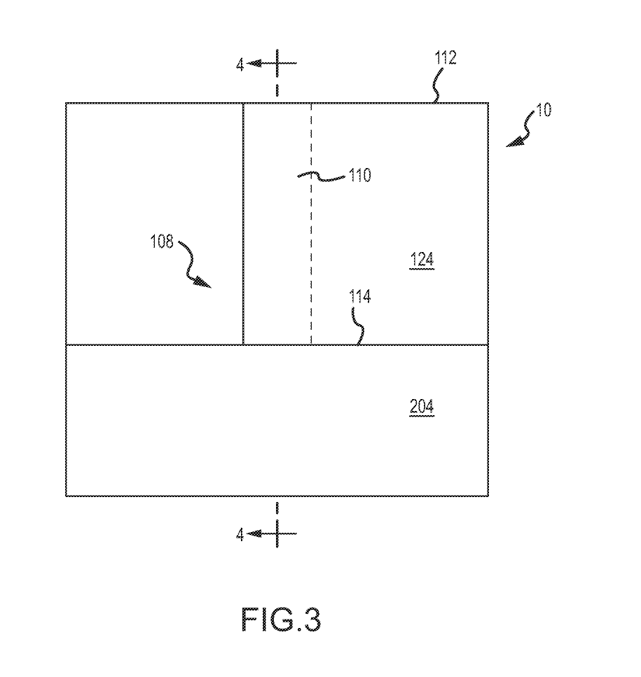

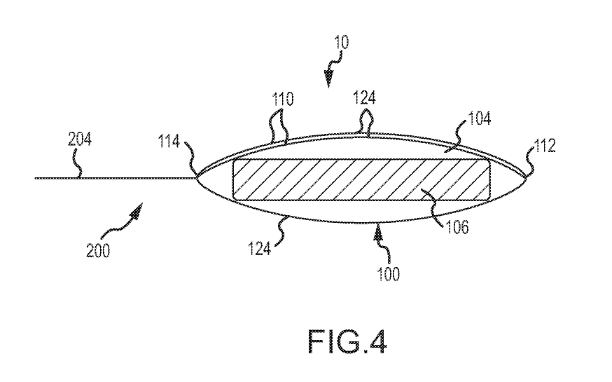

With additional reference to FIGS. 3 and 4, the bed portion 100 may include an interior space 104 defined by the one or more fabric panels 124 comprising the bed portion 100. In this regard, the interior space 104 may be sized to accommodate a cushioning member 106 therein to construct a pillow pet bed from the hybrid cover 10. In one particular embodiment, the cushioning member 106 may be a standard size head pillow (i.e., a pillow for use on a human bed). For example, such head pillows may come in a standard size of approximately 26 inches (66 cm) by 20 inches (51 cm). In this regard, the bed portion 100 may also be approximately 26 inches (66 cm) by 20 inches (51 cm). Alternatively, the bed portion 100 may have a width not less than about 24 inches (61 cm) and not greater than about 28 inches (71 cm) and a length not less than 18 inches (46 cm) and not more than about 24 inches (61 cm). Other sized pillows that are larger or smaller may be used as well. For example, a standard queen sized pillow may be 20 inches (51 cm) by 30 inches (76 cm) and a king sized pillow may be 20 inches (51 cm) by 36 inches (91 cm). As such, the bed portion may be approximately 20 inches (51 cm) by 30 inches (76 cm) or 20 inches (51 cm) by 36 inches (91 cm) to accommodate a standard queen sized pillow or a standard king sized pillow, respectively.

The bed portion 100 may include an opening 108 for receiving at least one cushioning member 106 into the interior space 104. For example, the bed portion 100 may include overlapping fabric portions 110. The overlapping fabric portions 110 may be secured along opposing edges 112 and 114 thereof, e.g., by stitching. In this regard, upon separation of the fabric portions 110, a cushioning member 106, e.g., a pillow, may be inserted into the interior space 104 of the bed portion 100. The overlapping fabric portions 110 may then be closed to retain the cushioning member 106 in the interior space 104. While not shown in FIG. 3 or 4, a closure may be provided on the overlapping fabric portions 110 to retain the overlapping fabric portions 110 closed. While depicted as having only one cushioning member 106 disposed within the interior space 104, additional (i.e., two or more) cushioning members 106 may be provided in the interior space 104.

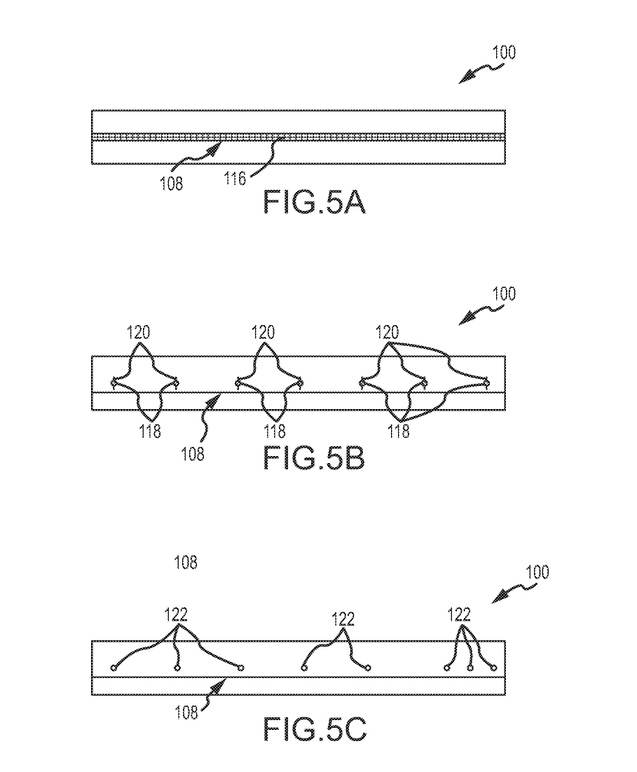

With further reference to FIGS. 5A-5C alternative embodiments of an opening 108 for accessing the interior space 104 are shown that include different types of closures to secure the cushioning member 106 within the interior space 104 of the bed portion 100. It will be appreciated that the opening 108 may in some embodiments be positioned at an end of the bed portion 100 as shown in FIGS. 5A-5C (e.g., an end opposite the end to which the flap portion 200 is attached). For example, in FIGS. 5A-5C, an end view of the bed portion 100 is depicted. In FIG. 5A, a zipper closure 116 may be used to secure the opening 108. The zipper closure 116 may be unzipped to selectively open the opening 108 for receipt of the cushioning member 106 within the interior space 104. With additional reference to FIG. 5B, the opening 108 may be secured by way of corresponding buttons 118 and button holes 120. Further still, as shown in FIG. 5C, coordinating snap closures 122 may be used to secure the opening 108. Other appropriate closure devices may be provided in order to secure the opening 108 in order to retainably engage the cushioning member 106 within the interior space 104.

In one embodiment, a pet bed constructed using the hybrid cover 10 may include an additional advantage over prior pet beds in that the scent of an owner or caretaker of a pet may be imparted onto the pet bed constructed using the hybrid cover 10. For example, in some instances, a pet may be comforted by providing an article having a scent that is comforting to the pet. For example, a blanket, stuffed animal, or some other object that includes the scent of the pet's owner or caretaker may be used to comfort a pet. However, this may require the owner or caretaker to adequately infuse a scent with an object to be provided to the pet. This may require the owner or caretaker to forfeit an often used item such as a blanket, stuffed animal, or other keepsake. However, as the hybrid cover 10 described herein may be adapted to accept a standard sized pillow to construct a pet bed, the owner or caretaker may employ a used pillow to provide the owner's or caretaker's scent to the pet bed constructed using the hybrid cover 10 and the used pillow, rather than otherwise disposing of the used pillow.

Accordingly, the one or more fabric panels 124 comprising the bed portion 100 may be permeable to smell. In this regard, a scent of a cushioning member 106 disposed in the interior space 104 may be smellable at an exterior of the bed portion 100. For example, a used pillow may smell of the pet's owner or the pet's caretaker. In this regard, when the pillow is disposed within the interior space 104 of the bed portion 100, the pet may be able to smell the scent of the cushioning member 106 when the pet is near the pet bed constructed using the hybrid cover 10 and the used pillow. Thus, the scent of the owner or caretaker may comfort the pet or attract the pet to the pet bed constructed using the hybrid cover 10 and the used pillow.

Furthermore, the use of a standard sized pillow, such as those commonly used for head pillows for humans, may allow for convenient and replacement of the cushioning member 106. For example, especially in the case of young and old pets, a pet may experience urinary incontinence when sleeping. As such, pet beds are particularly prone to becoming soiled. Previous pet beds may require costly or inconvenient cleaning upon becoming soiled. The cleaning or replacement of the cushioning member of previous pet beds may be particularly burdensome. However, with the use of a hybrid cover 10 and a standard sized pillow as a cushioning member 106, the hybrid cover 10 may be constructed from easily washable fabrics (e.g., such as those that are machine washable) and, even in the most extreme cases, the cushioning member 106 may be easily and conveniently replaced.

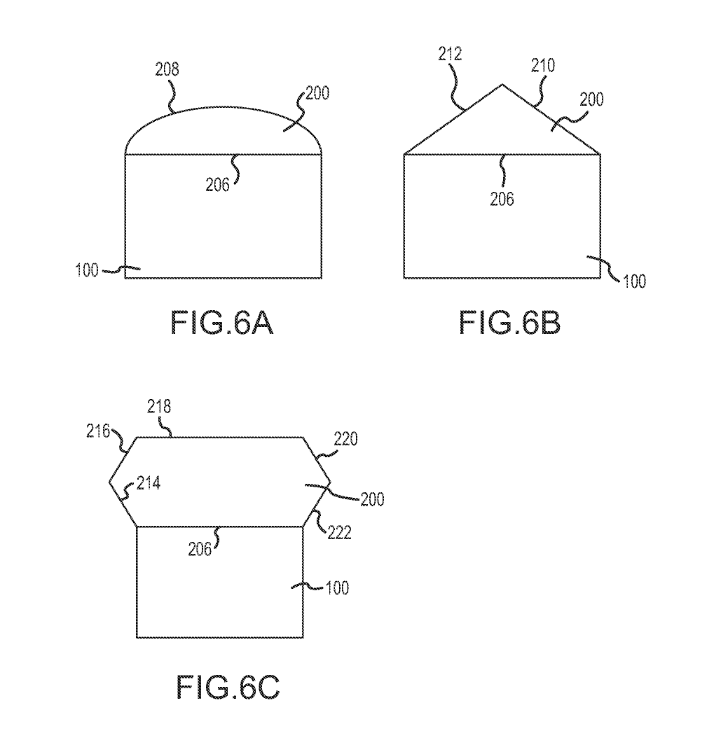

With further reference to FIGS. 6A-6C, alternative embodiments of the flap portion 200 are depicted. As shown in FIG. 1, the flap portion 200 may comprise a rectangular fabric layer 204 disposable between a non-overlapping and an overlapping position with respect to the bed portion 100. Alternatively, as shown in FIG. 6A, the flap portion 200 may include a first edge 206 attached to the bed portion and a second free edge 208 defining a semi-circular flap. Alternatively, as shown in FIG. 6B, the flap portion 200 may comprise two free edges 210 and 212. Other embodiments may be provided such as the embodiment shown in FIG. 6C wherein five free edges (214, 216, 218, 220, and 222) or more may be provided on the flap portion 200.

In any regard, the flap portion 200 may be disposed between an overlapping position and non-overlapping position. When in the non-overlapping position, the flap portion 200 may provide a relatively soft surface for the pet that extends beyond the bed portion 100 for the pet to use in addition to the surface provided by the bed portion 100. The flap portion 200 may protect an underlying surface such as a hard or carpeted floor or the like or may provide additional room for the pet when using the bed.

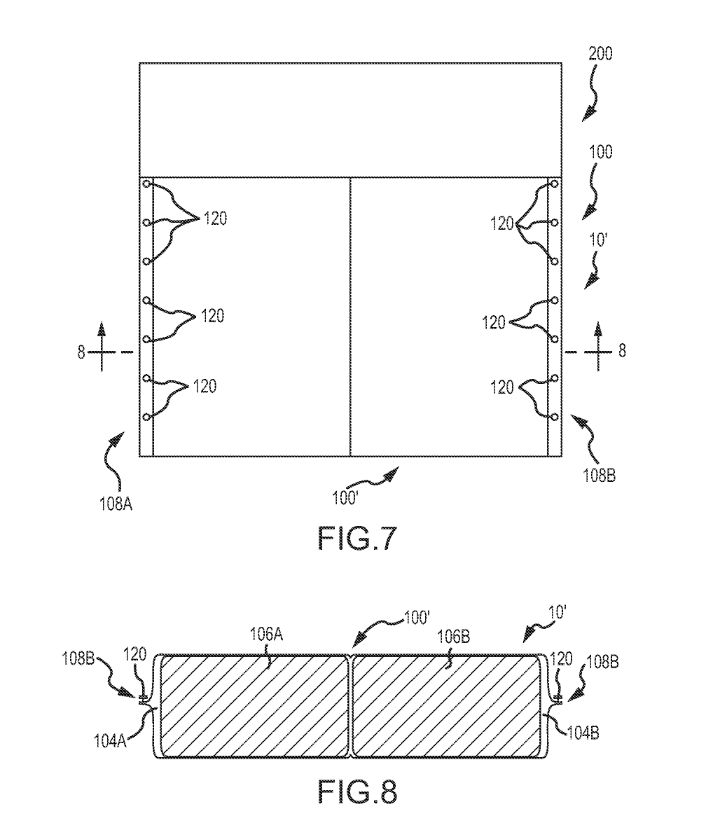

As described above, a plurality of cushioning members 106 may be disposed within the interior space 104 of a hybrid cover 10. With further reference to FIGS. 7 and 8, another embodiment of a hybrid cover 10′ is depicted. As depicted in FIGS. 7 and 8, a plurality of compartments 104A and 104B may be provided by a bed portion 100′ to receive corresponding ones of a plurality of cushioning members 106A and 106B therein. In this regard, each compartment 104A and 104B may include an opening 108A and 108B, respectively. Each opening 108A and 108B may be secured by closures. While button closures 120 are shown in FIGS. 7 and 8, it will be appreciated that other types of closures (e.g., zipper closures 116, snap closures 122, etc.) may be provided without limitation. Furthermore, additional compartments (i.e., more than two compartments) may be provided and/or each compartment may be sized to receive more than one cushioning member.

In another embodiment, a hybrid cover 10 may be provided that does not completely enclose the cushioning member within the interior space. For example, a hybrid cover having one or more straps that secure a cushioning member with respect to the bed portion may be provided. In one embodiment, such straps may be elastic so as to accommodate various sizes of cushioning members.

It will be appreciated that the hybrid cover 10 described herein may be particularly advantageous in the context of a packaged item for sale in a retail environment. As described above, many individuals have access to used pillows that are not currently in use, yet may be infused with the scent of a pet owner or caretaker. In this regard, the hybrid cover 10 according to the present disclosure may be packaged as a retail item for sale without a cushioning member provided therewith.

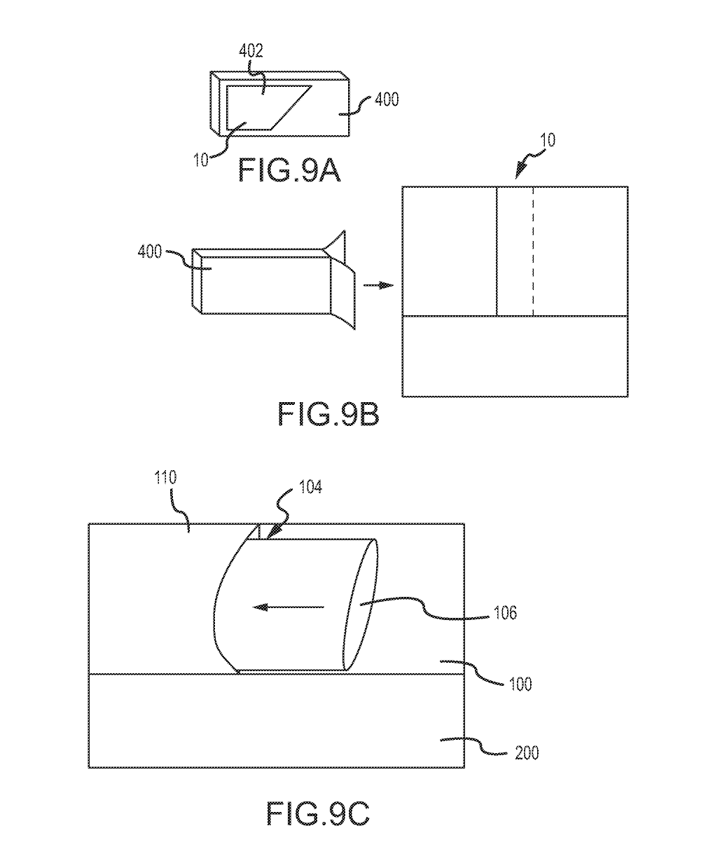

As shown in FIGS. 9A, a packaged item 400 may be provided. With further reference to FIG. 9B, it may be appreciated that the packaged item 400 may be smaller than the hybrid cover 10 in at least some dimensions such that the hybrid cover 10, without a cushioning member 106 therein, may be folded and disposed within the packaged item 400. A portion 402 of the packaged item 400 may be transparent (e.g., one of the panels or a portion thereof may be covered in a transparent material or may include an aperture) such that a hybrid cover 10 disposed in the packaged item 400 may be visible from an exterior of the packaged item 400. In this regard, a consumer may purchase the retailed packaged item 400 including the hybrid cover 10 without the cushioning member 106 being provided in the packaged item 400. The consumer may subsequently provide a cushioning member 106 (e.g., a used pillow) that may be disposed within the interior space 104 as shown in FIG. 9C to construct a pet bed using the cushioning member 106 and the hybrid cover 10. In this regard, the owner's scent may be provided on the pillow.

It will be appreciated that the relative size of the packaged item 400 without the cushioning member may be much smaller than a pet bed sold with a cushioning member. In this regard, the amount of retail display space required by the packaged item 400 may be smaller than the retail display space required by previous pet beds. Moreover, the cost of transporting the packaged item 400 containing the hybrid cover 10 without the cushioning member 106 may be significantly lower than the cost associated with transporting traditional pet beds shipped with a cushioning member. In this regard, the packaged item 400 may have a weight of not greater than about 1 lb. (0.45 kg), such as not greater than about 0.75 lb. (0.34 kg).

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. A hybrid cover for the construction of a pet bed, comprising:
a bed portion comprising at least one fabric panel defining an interior space that is selectively accessible from an exterior of the bed portion;
a flap portion secured to the bed portion and extending therefrom;
wherein the interior space is sized to receive at least a portion of at least one cushioning member within the interior space; and
wherein at least a part of the flap portion is displaceable with respect to the bed portion between an overlapping and non-overlapping position with respect to the bed portion.

2. The hybrid cover according to claim 1, wherein the bed portion comprises an opening through which a cushioning member is passed when the cushioning member is received in the interior space and the interior space completely receives the cushioning member.

3. The hybrid cover according to claim 2, wherein the opening is at least partially defined by overlapping fabric portions secured along corresponding opposing edges thereof.

4. The hybrid cover according to claim 2, wherein the opening is securable by a closure device.

5. The hybrid cover according to claim 2, wherein the at least one fabric panel is permeable to smell, wherein a scent of a cushioning member is smellable at an exterior of the bed portion when the cushioning member is disposed in the interior space.

6. The hybrid cover according to claim 1, wherein the flap portion includes an attachment portion secured to the bed portion and a free portion displaceable with respect to the bed portion.

7. The hybrid cover according to claim 6, wherein the attachment portion comprises a first edge portion of the flap portion, and wherein the free portion comprises at least a second edge portion of the flap portion displaceable with respect to the bed portion.

8. The hybrid cover according to claim 1, wherein the bed portion comprises a plurality of fabric panels, wherein a first fabric panel of the plurality of fabric panels comprises a first material and a second fabric panel of the plurality of fabric panels comprises a second material different than the first material.

9. The hybrid cover according to claim 8, wherein the first panel comprises a top surface of the bed portion and the first material comprises a fleece material.

10. The hybrid cover according to claim 9, wherein the second material comprises a taffeta material.

11. The hybrid cover according to claim 8, wherein the flap portion comprises at least one fabric layer.

12. The hybrid cover according to claim 11, wherein the at least one fabric layer of the flap portion is integral with the bed portion.

13. The hybrid cover according to claim 11, wherein the flap portion comprises a plurality of fabric layers, wherein a first fabric layer of the plurality of fabric layers comprises a third material and the second fabric layer comprises a fourth material.

14. The hybrid cover according to claim 13, wherein the first material is the same as the third material and the second material is the same as the fourth material.

15. The hybrid cover according to claim 1, wherein the interior space is sized to receive a standard sized human pillow.

16. The hybrid cover according to claim 15, wherein the bed portion is substantially rectangular in shape.

17. The hybrid cover according to claim 16, wherein the bed portion has a length not less than about 18 inches and not more than about 24 inches.

18. The hybrid cover according to claim 16, wherein the bed portion has a length that is about 20 inches.

19. The hybrid cover according to claim 16, wherein the bed portion has a width not less than about 24 inches and not more than about 28 inches.

20. The hybrid cover according to claim 19, wherein the bed portion has a width that is about 26 inches.

21. The hybrid cover according to claim 19, wherein the first edge of the flap portion extends along substantially the entire width of the bed portion.

22. The hybrid cover according to claim 1, wherein the interior space is sized to receive a plurality of cushioning members.

23. The hybrid cover according to claim 22, wherein the interior space comprises a plurality of compartments for receiving a respective one of the plurality of cushioning members.

24. A method of constructing a pet bed, the method comprising:
providing a hybrid cover including a bed portion and a flap portion, the bed portion comprising at least one fabric panel defining an interior space that is selectively accessible from an exterior of the bed portion via an opening provided in the bed portion;
passing a cushioning member through the opening and into the interior space;
closing the opening to retainably engage the cushioning member within the interior space to construct the pet bed; and
positioning the pet bed for access to the pet bed by an animal.

25. The method according to claim 24, wherein the interior space is sized to receive a standard sized human pillow, and wherein the cushioning member comprises a standard sized human pillow.

26. The method according to claim 24, further comprising:
moving the flap portion with respect to the bed portion between an overlapping position and a non-overlapping position.

27. The method according to claim 24, wherein the fabric panel is permeable to smell such that a scent of the cushioning member is smellable at an exterior of the bed portion when the cushioning member is disposed in the interior space.

28. A packaged item for sale in a retail location, the packaged item comprising:
a hybrid cover for the construction of a pet bed, comprising:
a bed portion comprising at least one fabric panel defining an interior space that is selectively accessible from an exterior of the bed portion,
a flap portion secured to the bed portion and extending therefrom,
wherein the interior space is sized to receive a cushioning member within the interior space, and
wherein at least a part of the flap portion is displaceable with respect to the bed portion between an overlapping and non-overlapping position; and
packaging material operable to contain the hybrid cover;
wherein the packaged item does not include a cushioning member for insertion into the interior space.
